(19) United States
(12) Patent Application Publication
(10) Pub. No.: US 2010/0104726 A1
(43) Pub. Date: Apr. 29, 2010

(54) SHELF STABLE BUBBLED CHEESE PRODUCT AND PROCESS FOR MAKING SAME

(75) Inventors: Karen Richardson, Oakville (CA); Alasdair Grant, Toronto (CA)

Correspondence Address: BASCH & NICKERSON LLP, 1777 PENFIELD ROAD, PENFIELD, NY, 14526, US

(73) Assignee: Freeze-Dry Foods Limited, Oakville (CA)

(21) Appl. No.: 12/604,071

(22) Filed: Oct. 22, 2009

Related U.S. Application Data
(60) Provisional application No. 61/107,999, filed on Oct. 23, 2008.

(51) Int. Cl. A23C 19/097; A23C 19/00

(52) U.S. Cl. 426/582; 426/385

(57) ABSTRACT

A shelf-stable savory crispy bubbled cheese product and a process for making it is provided wherein cheese pieces containing 50%-60% moisture are tempered followed by vacuum drying in the presence of a heat source followed by freeze drying in the presence of a heat source. The resulting cheese pieces retain or intensify the original cheese color, display no visible oils or chalky powder on the surface, and do not stick tightly or clump together. They are easy to break but not brittle and have a taste comparable to fresh cheese.

This application claims priority from U.S. Provisional Patent Application Ser. No. 61/107,999 for “SHELF STABLE BUBBLED CHEESE PRODUCT AND PROCESS FOR MAKING SAME,” filed Oct. 23, 2009 by K. Richardson and A. Grant, which is hereby incorporated by reference in its entirety.

This disclosure relates to a shelf-stable bubbled cheese product and a process for manufacture thereof. The process includes a tempering operation, preliminary vacuum drying, and freeze-drying to produce a shelf-stable product from cheese, without the use of preservatives or the like.

### BACKGROUND AND SUMMARY

Nutritious snack foods which are low in carbohydrates and/or fat, while maintaining pleasant organoleptic characteristics (e.g., flavor, aroma, texture, appearance, and so forth), are in demand by many consumers. Cheese is a flavorful milk-based product that is an excellent source of calcium, protein, and other nutrients, and is naturally low in carbohydrates.

Dried cheese-based products having a thin, crunchy texture have been sought in the past. For instance, U.S. Pat. No. 4,803,090 describes a process for producing a microwave puffed cheese snack in which hot viscous drops of cheese base material or processed cheese or slices or diced natural cheese, cheese base material, or process cheese are formed into pieces to provide cheese precursor pieces having a fat content in the range of 0-70 percent, particularly 17-34 percent, and a moisture content of 20-50 percent. The precursor pieces are baked in a convection oven, and simultaneously or subsequent to baking, are subjected to a microwave cooking and drying step to puff the pieces without oiling off. The moisture content of the cooked, dried puffed product is less than 5 percent of that of the starting precursor pieces.

International Publication No. WO03061394 A1 describes a method of preparing cheese products, in which cheese is subjected to a heat treatment, involving separating cheese parts having main dimensions between 1 and 10 mm from a solid cheese having a fat content of at least 30 percent and subjecting the cheese parts to a microwave treatment so as to from an airy cheese product. The cheese parts may be subjected to a drying step (forced air drying at less than 20 deg C. for 3-7 hrs) between the separating and microwave treatment steps.

French Patent 2,750,015 A1 describes a process for manufacture of a dried puffed cheese product where a cheese material having an initial moisture of 25-65 percent, is expansion dried using microwave energy to final moisture content of less than 10 percent. The starting cheese material is described as “pop-corn” type product from cheese curds made from whole milk, flavored cheese curds, cheese curds made from skim milk, or thin slices of cheese (1 mm thick)

Japanese Patent Publication 03-147752 describes a puffed food in which moisture is added to a substance containing protein as a main ingredient and a gelatinized grain flour, and puffing the mixture by microwave heating. The substance containing protein may be cheese, powdered milk or dried egg white powder, and the gelatinizing grain flour may be glutinous rice or waxy corn starch having amylopectin content, so that total moisture content in the raw material may be preferably 20-80 percent. The mixture is kneaded and rolled into, for example, a 3-10 mm thickness and cut into a proper size; the dough is then heated in a microwave oven to form a puffed and dried food.

Coating agents have been applied to cheeses in the past for various purposes. For instance, U.S. Pat. No. 5,876,770 describes a process and formulation for improved texture and melt of reduced-fat cheese products. This patent describes a hydrophobic material (viz, a fat or oil) used to prevent sticking in cheese.

U.S. Pat. No. 5,626,893 describes an anti-caking agent used for reducing the stickiness of diced or shredded cheese products. The anti-caking agent comprises fine mesh vegetable flour, bentonite, cellulose, and antimycotic agents or bacterial cultures. This patent is not concerned with drying of the cheese pieces or preventing them from sticking during melting.

U.S. Pat. No. 5,795,613 concerns nonpuffed dried cheese pieces of nonmelting cheese made by drying non-melting cheese pieces to a final moisture content, preferably between 2 and 8 percent, by dielectric heating, (e.g. microwave heating).

U.S. Pat. App. No 2006/0083842 describes a dried, crisp puffed cheese food product and a process for making it, whereby low fat cheese precursor pieces containing about 12 to about 24 percent moisture are contacted with polysaccharide, followed by holding them in a moisture-tight environment, prior to puffing the pieces using a microwave oven. The resulting snack food product comprises puffed cheese pieces having generally uniform expanded structures free of large voids and which do not stick tightly or clump to each other.

In spite of these and other efforts, there remains a need for shelf stable bubbled cheese snack product which can be produced without the use of anti-caking agents, preservatives or microwave drying. A process disclosed herein includes a tempering operation, vacuum drying, and freeze-drying to produce a shelf-stable product from cheese, without the use of preservatives or the like. The disclosed embodiments provide such a snack product by first tempering cheese pieces containing about 50%-60% moisture followed by vacuum drying followed by freeze drying to a water activity (a_{w}) lower than about 0.5. The resulting cheese pieces retain or intensify the original cheese color, are shelf stable, and have an expanded surface area with a non-uniform appearance and an internal structure with bubbles. The pieces display no visible oils or chalky powder on the surface, and do not stick tightly or clump together. They are easy to break but not brittle and have a taste comparable to fresh cheese.

In accordance with an aspect of the disclosed embodiments, there is presented a method for producing a shelf-stable savory crispy cheese product, comprising: providing cheese product with a moisture content of 50-60%; tempering the cheese product in a temperature controlled room to reach a target internal piece temperature of 40-50° F.; and freeze-drying the cheese product under a vacuum of about 1.5 torr or less, in the presence of a heat source at a temperature of about 135-155° F., to a water activity below about 0.5 a_{w}.

In accordance with another aspect of the disclosed embodiments, there is presented a cheese product produced by providing cheese product with a moisture content of 50-60%; tempering the cheese product in a temperature controlled room to reach a first piece temperature; and freeze-drying the cheese product under a vacuum, and at a second, higher, temperature to a water activity below 0.5 a_{w}.

### BRIEF DESCRIPTION OF THE DRAWINGS

FIG. 1 is a flow chart depicting a process for making a dried, crisp, bubbled cheese product according to an embodiment disclosed herein;

FIGS. 2A and 3A are exemplary pictures of shelf stable bubbled cheese products prepared in accordance with a process disclosed herein; and

FIGS. 2B-3B are illustrations of cheese products in a conventional freeze-dried form.

The various embodiments described herein are not intended to limit the scope to those embodiments described. On the contrary, the intent is to cover all alternatives, modifications, and equivalents as may be included within the spirit and scope defined by disclosure and the appended claims.

### DETAILED DESCRIPTION

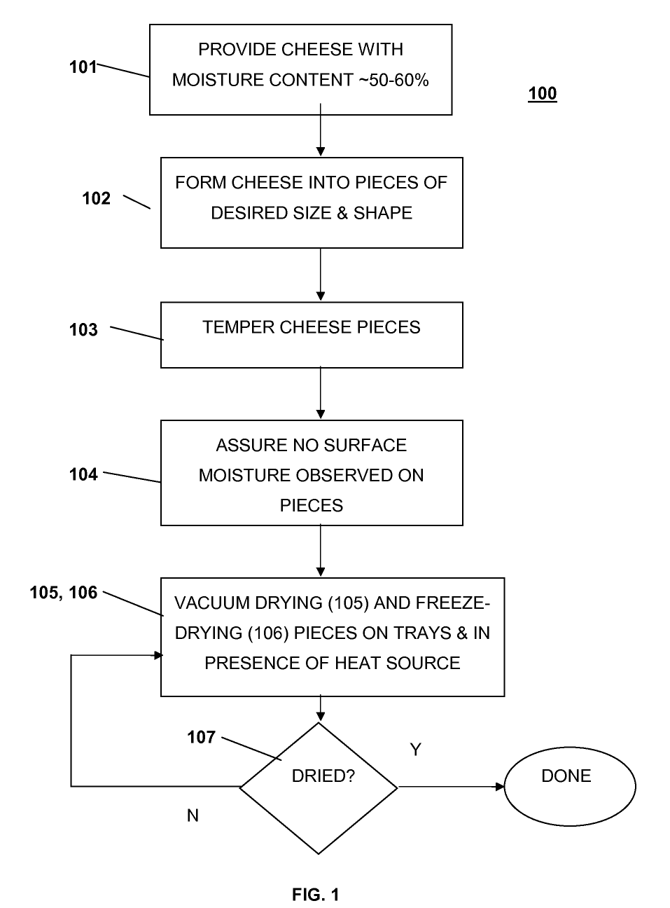

Referring to FIG. 1, a specialized process 100 is shown for making the shelf stable bubbled cheese product as described in more detail herein. Although various forms of cheese may be used, cheddar cheese is produced from block or trim with a moisture content of 50-60% (101), and is then cut or formed into a desired shape and size (102). In one embodiment, this shape is preferably rectangular with dimensions of about 1.75×1.0×0.25 inches, although other shapes and sizes such as cylinders, squares, spheres, ellipsoids, etc. are suitable and contemplated herein as well. In one embodiment, a cheddar cheese available from standard cheese supply source (e.g., from a manufacturer, distributor or retailer) was used, wherein the cheese is characterized as a standard low-fat cheddar cheese, and is believed to be consistent with the specifications of the USDA, for example, as set forth in 21 CFR §133, which is hereby incorporated by reference in its entirety.

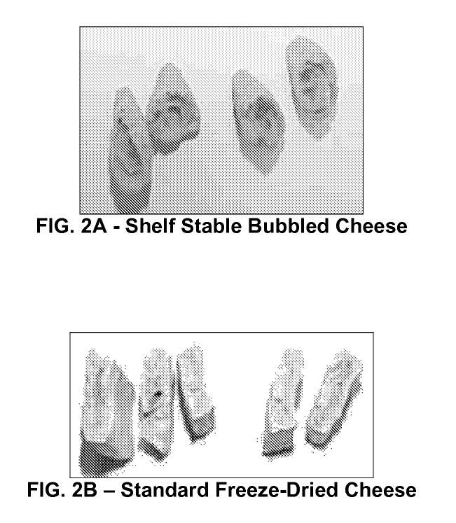

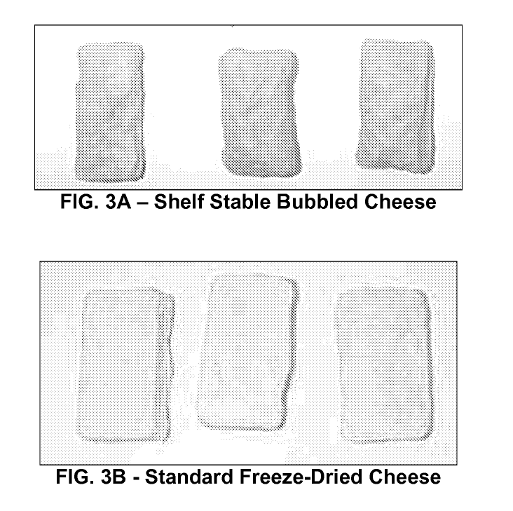

The cheese pieces are then placed or spread on aluminum or stainless steel trays (ribbed or flat) for tempering (103). The tempering operation lasts for approximately 6-16 hours, and is conducted in a temperature controlled room or environment until the cheese pieces reach a target internal piece temperature of about 40-50° F. (103). The cheese pieces are then loaded into a vacuum chamber (105). Before being subjected to the vacuum drying and freeze-drying operation, care must be taken to assure that any moisture condensed on the surface of the pieces has had an opportunity to evaporate or be reabsorbed (104). Absence of moisture on the surface of the pieces should be confirmed by observation before the next process step is initiated. As they are placed on the trays, the pieces may overlap and overlay as several layers on the trays. The vacuum chamber, for example a freeze-dryer, manufactured by Stokes, is then placed under a vacuum of about 1.5 torr or less (105). During the vacuum draw down process, the water in the cheese will “boil” and then turn to ice where the process of sublimation will take over. The low atmospheric “boiling” causes internal pressure in the cheese and results in internal bubbling and external structural changes in the cheese pieces. Heat is then introduced (106) to the vacuum chamber after achieving the targeted vacuum level. The heat energy is introduced through a circulating heating medium (e.g., plate coil beneath trays or shelves on which the trays are placed). The heating medium provides a source of heat at about 135-155° F. beneath the freeze-drying shelves. The early introduction of heat causes the outer surfaces of the cheese pieces to become softer and more homogeneous than the internal structure. The remaining ice in the cheese pieces continues to sublimate throughout the cycle (approximately 7-12 hours) after the internal pressures within the cheese have caused internal bubbles and visible irregular external structural changes to the surface (see FIGS. 2 and 3). The process ends when the water activity in the cheese is below about 0.5 a_{w} (107).

### EXAMPLE

The method disclosed above was used to produce a shelf-stable savory crispy bubbled cheese product. The process started with cheese product having a moisture content of about 50% and not more than about 60%, and the cheese product was tempered to achieve a piece temperature of about 40-50° F. Then, the product was vacuum dried in the presence of a heat source until visible external structural changes occurred. Once dried sufficiently, the product was then freeze-dried under a vacuum of about 1.5 torr, at the end in the presence of heat to achieve a temperature of about 135° F. and a resulting water activity below 0.5 a_{w}.

The resulting product, as depicted in FIGS. 2A and 3A, was a shelf-stable bubbled cheese product, and the cheese color should approximate that of typical room temperature cheese of the same type. The product of FIGS. 2A and 3A may be contrasted with the products of FIGS. 2B and 3B, respectively.

It will be appreciated that various of the above-disclosed embodiments and other features and functions, or alternatives thereof, may be desirably combined into many other different systems or applications. Also, various presently unforeseen or unanticipated alternatives, modifications, variations or improvements therein may be subsequently made by those skilled in the art which are also intended to be encompassed by the following claims.

What is claimed is:

1. A method for producing a shelf-stable cheese product, comprising:
providing cheese product with a moisture content of at least about 50%;
tempering the cheese product in a temperature controlled area until the cheese product reaches a first temperature;
vacuum drying the tempered cheese product in the presence of heat and thereby causing internal bubbling and visible external structural changes;
freezing any remaining moisture in the cheese by freeze-drying the cheese product under a vacuum, in the presence of heat and at a second temperature above the first temperature, to produce a water activity below about 0.5 a_{w}.

2. The method of claim 1, wherein the cheese product is pre-formed into a rectangular block having a volume of approximately 0.438 cubic inches.

3. The method of claim 1, wherein the first temperature is in the range of about 40 degrees F. to about 50 degrees F.

4. The method of claim 1, wherein the second temperature is in the range of about 135 degrees F. to about 155 degrees F.

5. The method according to claim 1, wherein freeze-drying the cheese product occurs under a vacuum of up to about 1.5 torr.

6. The method according to claim 1, further including observing the pieces after tempering to assure no surface moisture is present on the pieces.

7. The method according to claim 1, wherein freezing any remaining moisture in the cheese by freeze-drying the cheese product under a vacuum is carried out before applying heat and at the second temperature.

8. The method according to claim 7, wherein the heat is supplied using a plate coil with a heating medium circulating therethrough.

9. The method according to claim 7 wherein the freeze-drying operation occurs for at least about approximately seven hours.

10. A cheese product produced in accordance with the method set forth in claim 1.

11. A method for producing a shelf-stable savory crispy bubbled cheese product, comprising:
providing cheese product with a moisture content of 50-60%;
tempering the cheese product in a temperature controlled room to reach a target internal piece temperature of 40-50 degrees F.;
vacuum drying the tempered cheese product in the presence of a heat source causing internal bubbling and visible external structural changes;
freezing the moisture in the cheese and freeze-drying the cheese product under a vacuum of about 1.5 torr or less, in the presence of a heat source at a temperature of about 135-155 degrees F., to a water activity below 0.5 a_{w}.

12. The method of claim 11, wherein the cheese product is pre-formed into a rectangular block having a volume of approximately 0.438 cubic inches.

13. A cheese product produced in accordance with the method set forth in claim 11.
